(19) United States
(12) Patent Application Publication
(10) Pub. No.: US 2017/0090891 A1
(43) Pub. Date: Mar. 30, 2017

(54) METHOD AND DEVICE FOR ASSISTING WITH CODE OPTIMISATION AND PARALLELISATION

(71) Applicant: COMMISSARIAT A L'ENERGIE ATOMIQUE ET AUX ENERGIES ALTERNATIVES, PARIS (FR)

(72) Inventors: Alexandre GUERRE, MONTIGNY-LE-BRETONNEUX (FR); Yves LHUILLIER, PALAISEAU (FR); Jean-Thomas AQUAVIVA, PARIS (FR)

(21) Appl. No.: 15/126,820

(22) PCT Filed: Mar. 11, 2015
(86) PCT No.: PCT/EP2015/055040

§ 371 Date: Sep. 16, 2016

(30) Foreign Application Priority Data
Mar. 20, 2014 (FR) 1452304

(51) Int. Cl. G06F 9/45; G06F 9/44

(52) U.S. Cl. CPC G06F 8/443; G06F 8/456; G06F 8/71; G06F 17/30598

(57) ABSTRACT

A method and a device for aiding code optimization and parallelization of an application executes on a computer and consists in comparing a code portion representing a hot spot of the application with a plurality of non-optimized code versions to determine a correlation with at least one non-optimized code version. The method makes it possible to generate on the basis of the non-optimized code version, performance predictions for various architectures and according to various models of parallel programming for the hot spot.

### FIELD OF THE INVENTION

The invention relates to the field of software engineering for parallel architecture, and in particular that of aiding code optimization and parallelization.

### PRIOR ART

The field of software engineering is often decomposed into sub-fields which include:

the analysis and profiling of an application code for its optimization;

the evaluation and comparison of performance in terms of execution speed and electrical consumption of various computation architectures, a field known as “benchmarking”;

the modeling and prediction of the performance of an application code targeting several varied computation architectures; and

aiding the porting, parallelization and optimization of a code onto a target architecture.

In general, code optimization consists in making modifications to the code with the aim of reducing the needs in terms of resources, by decreasing the execution times of functions or by improving electrical consumption. Depending on the type of architecture, sequential or parallel, on which the code operates, tools exist for aiding code optimization. For sequential architectures, it is known to use a C-language description of a sequential algorithm. However, for parallel architectures which require great expertise, code optimization involves human intervention. Now, human intervention very often introduces variability into the quality of the codes generated for each of the parallel-computation architectures. This variability raises various problems, in particular that related to the comparison of two parallel architectures where the result of the analysis is subjective since it is highly dependent on the expertise of the developer of the architectures studied.

Another problem is related to the prediction of the performance of a new application code for several target architectures, the prediction may be inaccurate since it is dependent on the human expertise of the developers involved in porting the code.

Finally, it is often difficult to synthesize the expertise of developers relating to parallel architectures, because it is often distributed over several developers across the world. It becomes in fact still more difficult to reuse this expertise between developers.

Among the known solutions for aiding code optimization or for aiding code parallelization, some integrate to various degrees an approach based on the synthesis of expertise, such as the solutions described in the following documents.

Patent application US 2009/0138862 A1 by Tanabe proposes a device for aiding parallelization, which carries out an analysis of dependencies so as to extract the opportunities for parallelization within a program. In this device, the parallelization opportunities correspond to the statistically possible parallelizations for a given application. No indication is provided as regards the parallelization procedure, or as regards the potential gains. In this respect, professional expertise relating to parallelization is not taken into account.

The thesis document by Grigori G. Fursin, entitled “Iterative Compilation and Performance Prediction for Numerical Applications”, 2004 proposes a synthesis of expertise in aiding optimization. However, this expertise is not used for aiding parallelization.

The article by Eric Petit et al. entitled “Computing-Kernels Performance Prediction Using data flow Analysis and Microbenchmarking”, published in the “16th Workshop on Compilers for Parallel Computing (CPC 2012), Padova, Italy (2012)” presents a procedure for accumulating and reusing expertise relating to fine-grain code optimization and for sequential architectures. Parallelization is therefore not taken into account.

However, no known approach proposes establishing a link between the characterization of an application, that is to say the recognition and decomposition into known sub-problems, and a parallelization technique database.

Thus, no known solution exists which enables a set of parallel architectures to be programmed in a generic and portable manner without human intervention.

Hence the need exists to provide a device and a method for code optimization which includes synthesization and formalization of the expertise of developers of parallel architectures.

### SUMMARY OF THE INVENTION

An object of the present invention is to propose a method making it possible to synthesize and to formalize the expertise of developers of parallel architectures so as to allow any developer to be able to undertake an assessment of the performance and consumption of application codes on varied computation architectures.

The technical advantages of the present invention are to allow assessment of the performance and consumption of application codes on varied computation architectures, without requiring the intervention of expert developers, or the porting of the codes onto the envisaged architectures.

Advantageously, the device of the present invention makes it possible to assist a developer with the effort of porting a code from a source architecture to a target architecture, starting from a non-optimized application code in a language that is natively compilable on a reference platform, such as the C, C++, fortran languages for example.

The device of the invention advantageously comprises a database of existing experimental measurements which can be enriched. The measurements are either carried out by the operator of the method or imported from outside experiments. Each experimental measurement consists of the evaluation of the performance of several reference application codes on several target architectures. Each reference application code is available in a non-optimized and sequential version, allowing direct evaluation of the performance on a unique core of each target architecture. Each reference code is also available in a parallelized and optimized version for each target architecture.

Advantageously, the invention will find application in carrying out studies regarding choice, implementation, envisageable performance with a view to porting applications onto new architectures.

In particular, the invention will apply to the industrial field where application codes often evolve less rapidly than parallel computation architectures, and where the problem of porting an existing application code onto new parallel architectures is crucial.

Advantageously, the present invention makes it possible to assist industries to port “professional” application codes to advanced parallel architectures whose complexity may be difficult to master.

Finally, the method of the invention makes it possible to rate and compare new parallel architectures so as allow better appraisal of an offer available on the market.

To obtain the sought-after results, a method, a device and a computer program product are proposed.

In particular, a method for aiding code optimization and parallelization of an application executing on a computer comprises the steps of:

comparing a code portion representing a hot spot of an application with a plurality of non-optimized code versions so as to determine a correlation with at least one non-optimized code versions; and

generating on the basis of said at least one non-optimized code version, performance predictions for various architectures and according to various models of parallel programming for said hot spot.

In one embodiment, the comparison step consists in computing a coefficient of correlation between said hot spot and the plurality of non-optimized code versions.

In a variant, the comparison step comprises a step of generating a signature for said hot spot and of comparing the signature with a plurality of signatures associated with the plurality of non-optimized code versions.

Advantageously, the step of comparison between the signatures is performed according to a principal component analysis (PCA).

Still advantageously, the signatures associated with the plurality of non-optimized code versions contain at least metrics relating to the stability of a data flow, to a parallelization ratio, to a reuse distance of the data flow and to a data volume.

In an implementation, the plurality of non-optimized code versions is stored in a reference database where each non-optimized code version is a non-optimized code version for a reference platform and is associated with various optimized code versions parallelized on various architectures and according to various models of parallel programming.

In one embodiment, the various optimized code versions parallelized on various architectures and according to various models of parallel programming are stored in a porting database and the step of generating predictions consists in extracting porting data for said non-optimized code version.

Advantageously, the method moreover comprises a step which makes it possible to display the result of the predictions for a user.

In one embodiment, the result is displayed in the form of Kiviat charts.

The method can comprise an initial step of receiving an executable code of an application to be optimized and parallelized and a step of detecting in the executable code a code portion representing a hot spot.

The invention also covers a device which comprises means for implementing the method.

The invention can operate in the form of a computer program product which comprises code instructions making it possible to perform the steps of the claimed method when the program is executed on a computer.

### DESCRIPTION OF THE FIGURES

Various aspects and advantages of the invention will be apparent in support of the description of a preferred but nonlimiting mode of implementation of the invention, with reference to the figures hereinbelow:

FIG. 1 schematically shows a device in which the invention can be implemented;

FIG. 2 shows a flowchart of the steps of the procedure of the invention in an embodiment;

FIG. 3 illustrates in the form of radar-like charts the result of the method of the invention for an exemplary application.

### DETAILED DESCRIPTION OF THE INVENTION

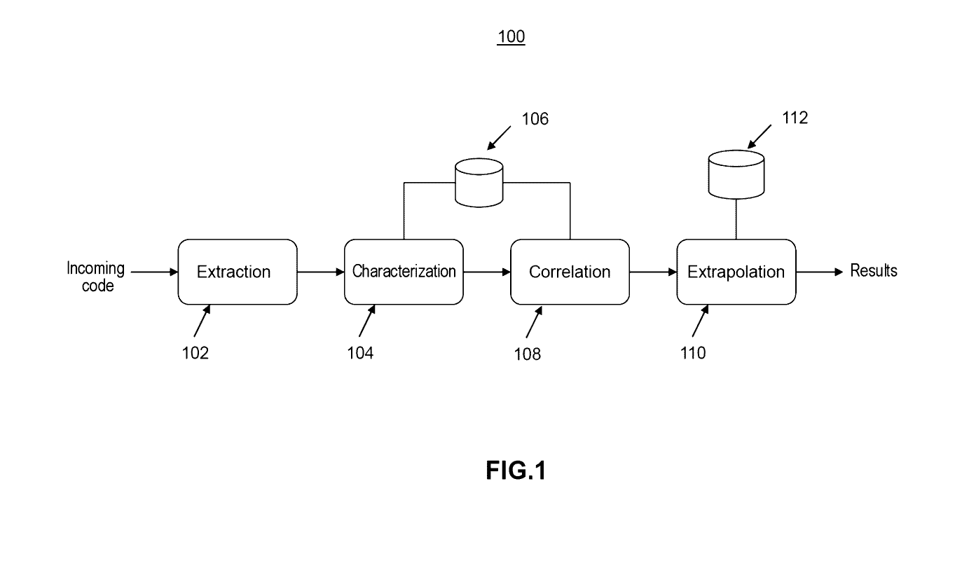

Reference is made to FIG. 1 which shows in a schematic manner the modules of the device of the invention.

The device of the invention (100) comprises an extraction module (102) able to analyze a non-optimized executable code representative of an application and to extract hot spots of the code. The hot spots are portions of the code penalizing the performance of the application. In general, these portions represent the least code line for the largest execution time.

The hot spots are non-optimized portions of code representing discernable and compact phases of the original application.

The incoming executable code entering the extraction module is a code generated, by a compilation device, on the basis of the source code of the application to be analyzed. Although not shown in FIG. 1, the person skilled in the art understands that the executable code can be either a file available in the direct environment of the device (100), stored on an internal disk of a computer implementing the device and operated by a user, or a file originating from a close or distant external source. The executable code can thus originate from a compiler which transforms a source code into the C/C++ or Fortran language. In an implementation, the executable code is executed by an emulator so as to extract therefrom the appropriate characteristics. In a concrete example of an application taking an image as input and producing as output an image of the contours of the input image, the device (100) performing the analysis of the executable code of this application, emulates the execution of the executable code on its dataset. In this example, the dataset of the application is the input image.

The extraction module (102) is coupled to a characterization module (104) able to characterize the hot spots extracted from the code. In one embodiment, the characterization of the hot spots consists in computing a signature for each hot spot extracted from the incoming code.

The characterization module is also coupled to a database (106) of reference microkernels.

The base (106) is an empirical knowledge base of known optimization and parallelization techniques, either originating from the operator of the method, or originating from outside sources, and consisting of reference microkernels. In one embodiment applied to the field of image processing, the knowledge base contains six reference microkernels making it possible to cover as broadly as possible the algorithmic space of vision. The reference microkernels are chosen as a function of several parameters such as the type of access to the data, for example a linear or random input image traversal, such as the regularity of the data, for example the fact that the nature of the computations is foreseeable before execution or on the contrary if the nature of the computations depends on the intermediate computations at the time of execution, such as the complexity of the data, for example the number of different computations performed on a single datum (on each pixel of an image for example).

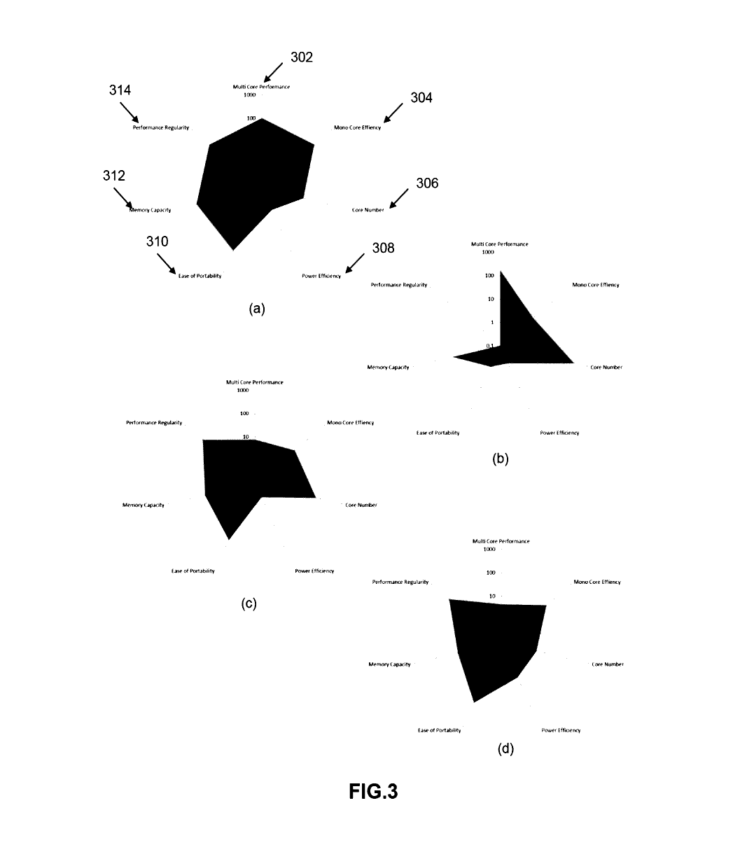

Each reference microkernel possesses a non-optimized code version which corresponds to a basic way of coding on a reference platform and various optimized code versions parallelized on various architectures. In the example described and illustrated by FIG. 3, the reference platform is an x86 processor. The input images are generated randomly and the measurements are made on various image sizes. The multitude of parameters on the input images makes it possible to characterize the algorithm of the microkernel independently of its inputs. The database of measurements which is obtained possesses four input axes: (1) the target architecture, (2) the microkernel, (3) the size of the dataset at input and (4) the type of parallelization relating to various models of programming (for example, parallelization at the data level or parallelization at the task level) and of optimization.

The person skilled in the art will understand that the database is not limited in the number of reference microkernels. The microkernels can originate from outside sources, provided by or retrieved from developers worldwide so as to accumulate past expertise. The choice of microkernels is made as a function of a field of application so as to increase the precision and relevance of the method.

The characterization module (104) makes it possible to compute a signature for any execution of an executable code on an input dataset. The module makes it possible to compute the signature of each reference microkernel of the knowledge base, on each of its input datasets. The computation of the signatures of the reference microkernels is performed just once, during integration of the reference microkernel into the database, consisting of a calibration process. This computation is performed before using the device on an input application. During use for a given application, the characterization module makes it possible to undertake the computation of signatures of the extracted hot spots by executing the executable code of the input application with its dataset.

The output of the signature module 104 is coupled to the input of a correlation module (108) which is itself coupled to the reference microkernels base. The correlation module makes it possible to establish correlations between the signature of a code portion extracted from the code of the input application and the signatures of the reference microkernels of the knowledge base 106.

The output of the correlation module is coupled to the input of an extrapolation module (110). The extrapolation module is also coupled to a porting database (112) which contains the data relating to the portings of the reference microkernels to diverse parallel architectures. In a preferential manner, the porting architectures are representative of a suite of existing parallel architectures.

The extrapolation module makes it possible, by extracting appropriate data from the porting database 112, to establish predictions or projections of the performance of the microkernels extracted from the incoming code on the various architectures and per parallel programming model.

The result of the extrapolations is thereafter available as output from the extrapolation module and can be presented to the user in various forms such as that illustrated for example in FIG. 3 by Kiviat charts.

The data contained in the reference base also make it possible to produce statistical predictions of the performance of the application once parallelized, on measurements such as execution times, a number of monopolized resources or else for example an electrical consumption.

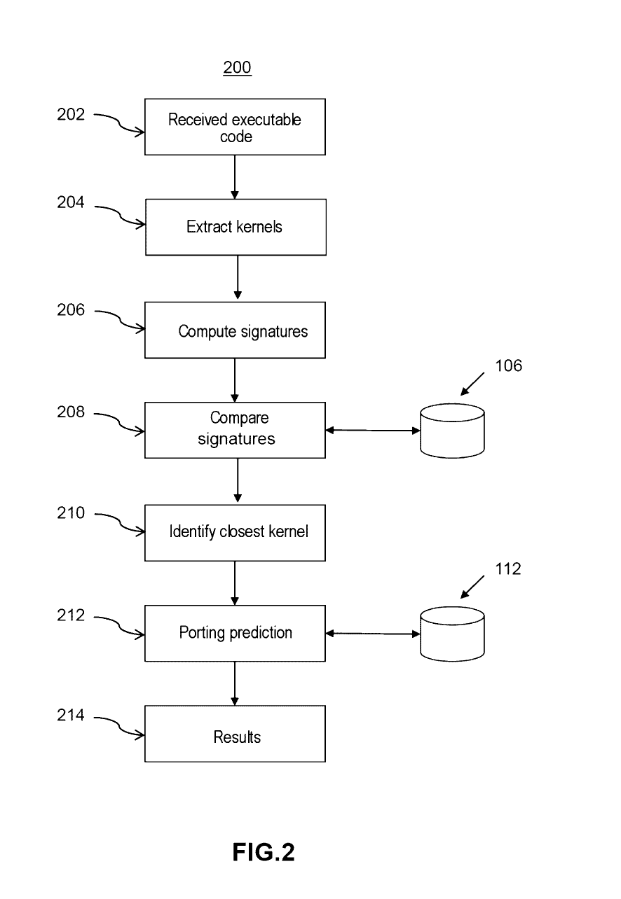

FIG. 2 illustrates the steps operated by the method 200 of the invention in a preferential implementation.

For the analysis of an application having to be ported to a new architecture, the method starts with a step (202) of receiving an executable code representative of the application. The executable code can be in the C, C++ or Fortran language or any other language that is natively compilable on the reference machine. The code to be analyzed is a non-optimized code.

In a following step (204), the method makes it possible to search for hot spots in the code. The application kernels that are extracted will be the parts of the code that will be optimized as will be detailed further on.

The step of extracting application kernels consists in decomposing the code, and searching for long continuous portions of execution of the program “discernable portions” and involving a minimum number of instructions of the program “compact portions”.

In a preferential embodiment, the extraction step is operated with a tool based on an x86 processor functional emulator. However, other tools carrying out an extraction of program hot spots can be used such as well-known profiling and sampling tools like GProf or Oprofile.

Once a hot spot has been found, the static instructions of the code are extracted to preserve only the portions corresponding to the original source code.

The method makes it possible to test whether the hot spot found covers a major part of the code of the application. In the converse case, the method repeats the step of searching for and extracting hot spots on the remainder of the code. Advantageously, the step of searching for and extracting hot spots is done on the traces of dynamic instructions.

The following step (206) allows the characterization of the kernel(s) extracted by computing a signature representative of each hot spot. In one embodiment, the signature is computed with the aid of the same emulator as that used for the extraction step, and contains several metrics: (1) the stability of the data flow, (2) the parallelization ratio, (3) the reuse distance of the data flow and (4) the data volume.

The stability of the data flow is an indicator of the mean number of locations of producers for each of the instructions. It makes it possible to sense whether the computations follow a fixed data stream circuit or whether some data are subject to complex address computations. In the latter case, continuous architectures such as GPUs would not be efficient targets. Furthermore, stability of the poor data streams may lead to limited possibilities of parallelization, since it implies that numerous dependencies are revealed during execution.

The parallelization ratio computes, on an ideal data stream graph, the ratio between the ideal width of parallelism and the number of instructions executed. A high value of this indicator implies high possibilities of parallelization.

The reuse distance of a flow of data gives the mean time that a data byte must be stored before reusing them. This measurement is evaluated on an ideal data stream graph and makes it possible to ascertain the ideal locale of data that a kernel contains and to determine whether the kernel would favor a wide bandwidth or an architecture with low latency.

The data volume evaluates the total volume of data that the code executes. This information is significant since the other signature parameters are independent of the data volume, they all being computed with respect to the number of instructions executed.

Advantageously, these metrics are independent of the hardware as far as possible so as to measure information relating to the application rather than in relation to the architecture.

However, the person skilled in the art will appreciate that new metrics can be taken into account.

The synthetic metrics in this embodiment originate from a richer intermediate representation consisting of a graph folded back in time of the whole set of interactions between the various instructions of the executable input code. Advantageously, an intermediate representation is preserved with the signature so as to make it possible to rapidly recompute new metrics without having to reproduce step 206.

Thus step 206 makes it possible to allot a signature to each application kernel of the non-optimized code version.

The following step (208) consists in comparing the signature previously computed for an application kernel with signatures of reference microkernels. Advantageously, the method makes it possible to search, via a signature of a non-optimized code version, through the reference microkernels base 106 and to correlate a non-optimized application kernel with a non-optimized reference microkernel. In one embodiment, the inter-signatures correlation computation is performed according to a principal component analysis (PCA).

In the following step (210), the method makes it possible to select for each application kernel, the closest reference microkernel, retaining the reference microkernel exhibiting an optimum distance with the application kernel.

The following step (212) consists for each non-optimized microkernel, in extrapolating the performance of the non-optimized code on the target architectures, by referring to data of the optimized-portings database which relate to the selected optimum microkernel.

The extrapolated performance is essentially the consumption and the speed of execution of a program, after parallelization and optimization.

The extrapolation consists in extracting from the portings database 112 the relevant data for the non-optimized microkernel studied. Extrapolation allows performance assessment based on concrete and empirical portings arising from professional expertise.

The result of the extrapolation (214) can be presented to the user in various forms, so as to make it possible to select the target platform appropriate to their constraints.

FIG. 3 illustrates results obtained by the method of the invention within the framework of an analysis of a code relating to an image processing application.

In the example described, the reference microkernels base (106) is composed of the following six microkernels:
Max 3×3;
Deriche filter;
Federico Garcia Lorca filter (FGL);
Quad-tree variance computation;
Calculation of integral image;
Matrix multiplication.

The ‘Max 3×3’ kernel is well known to the person skilled in the art as a 2D memory access filter, which performs more memory accesses than operations.

The ‘Deriche Filter’ and ‘FGL Filter’ kernels are respectively x8 and x4 1D filters. These filters have horizontal and vertical crossed access patterns and their dependencies are causal and anti-causal.

The ‘Quad-tree variance computation’ kernel is an algorithm which partitions the image into zones of low variance. This algorithm exhibits a recursive behavior through the fact that it increasingly finely partitions the zones of the image with large variance. By construction this algorithm is also strongly dependent on the data (values of the pixels of the image).

The integral image is an algorithm which computes, for each destination pixel, the sum of all the source pixels on top and to the left of the destination pixel. This algorithm exhibits a diagonal layout of dependencies which is present in numerous image processing algorithms.

The ‘Matrix multiplication’ microkernel is a well-known algorithm which exhibits an entirely characteristic 3D access pattern.

Four programming models have been used in the example described: OpenMP (Open Multi-Processing) which is a programming interface for parallel computation, Farming, OpenCL (Open compting Language) and CUDA (Compute Unified Device Architecture). The “farming” model was developed in C with the aid of the PThread library. In this model, the task to be performed is split up into numerous independent sub-tasks executed on work threads in smaller number. OpenCL and CUDA are standard languages used to program graphical processors (or Graphics Processing Units GPUs). OpenCL is also used for Intel® multi-processors.

In the example illustrated, the input dataset corresponds to images whose size is in a span ranging from 256*256 to 2048*2048 pixels.

Thus, the parameters of the reference base used by the method are:
A set of target parallel architectures;
A set of reference microkernels;
Input datasets, of different and progressive sizes;
A set of parallel-programming models.

In a variant, it is also possible to vary the number of processors used by the target architecture, if the latter so permits.

Returning to the example of FIG. 3, four target architectures have been characterized in the database: (a) Intel Xeon Core i7-2600; (b) ARM Cortex A9 quadcore; (c) Tilera TilePro64 and (d) Nvidia Geforce GTX 580.

Once the application microkernel extracted from the application has been associated with a reference kernel of the database, a prediction of the performance is carried out. This prediction gives an insight as to the best architecture and the best programming model to be used. Once a ‘programming model/architecture’ pair has been chosen, measurements of acceleration (m_speedup) can be extracted from the database. To compute the final execution time on the target platform (Predicted_time), a sequential efficiency ratio (arch_factor) between the reference architecture and the tested architecture is also necessary.

When using extraction tools, none of the application microkernels extracted can overlap, the microkernels are then independently parallelized. The following formula (1) can be used to compute a potential execution time for the parallelized application:

$$Predicted\_time = seq\_ref \_time \times arch\_factor + \frac{seq\_kernel \_ref \_time \times arch\_factor}{m\_speedup} \qquad ( 1 )$$

where the variable ‘Seq_ref_time’ represents the sequential execution time of the portions of the application that are outside the hot spots. The variable ‘Seq_kernel_ref_time’ represents the sequential execution time of the code portions of the application corresponding to the hot spots.

Advantageously, a correlation between the microkernels extracted provides a confidence coefficient that can be used to determine whether the selected reference kernel is actually very close to the kernel of the application.

The method of the invention makes it possible moreover to perform a correlation between the reference kernels and thus evaluate maximum and mean values for the confidence coefficient, the minimum values being always at zero and corresponding to kernel comparisons with themselves. The reference kernels selected are considered to be good candidates when their confidence coefficient (in comparison with the application kernels) is below a minimum confidence coefficient of two different reference kernels.

FIG. 3 shows respectively, for each of the four architectures studied, the results obtained by operating the method of the invention according to seven parameters: (302) Multicore performance; (304) Single-core efficiency; (306) Number of cores; (308) Energy efficiency; (310) Ease of porting; (312) Memory capacity; (314) Regularity of performance. Even without a detailed forecast of the performance of an application, these visual charts offer a user a fast comparison between the four target platforms for these parameters and aid in the selection of the most promising platform.

Although the example illustrated is essentially for a performance prediction computation, the method of the invention makes it possible to execute it for other predictions, such as for example latency measurements.

The person skilled in the art will consider that the present invention may be implemented on the basis of hardware and/or software elements and operate on a computer. It may be available as a computer program product on a computer readable medium. The medium may be electronic, magnetic, optical, electromagnetic or be a dissemination medium of infrared type. Such media are for example, semi-conductor memories (Random Access Memory RAM, Read-Only Memory ROM), tapes, magnetic or optical diskettes or disks (Compact Disk-Read Only Memory (CD-ROM), Compact Disk-Read/Write (CD-R/W) and DVD).

1. A method for aiding code optimization and parallelization of an application, the method executing on a computer and comprising the steps of:
identifying in a non-optimized executable code of an application, a code portion termed a “hot spot” penalizing the performance of the application;
determining a correlation between said “hot spot” and at least one reference version of non-optimized code from among a plurality of reference versions of non-optimized code grouped together in a database, the database further comprising porting data relating to portings of the reference versions of non-optimized code to various versions of optimized code which are parallelized on various architectures;
extracting from the porting database the porting data associated with the at least one reference version identified during the correlation step; and
using the extracted porting data to generate predictions of performance for various architectures and according to various models of parallel programming for the optimized “hot spot” portion of code.

2. The method as claimed in claim 1 wherein the comparison step consists in computing a coefficient of correlation between said hot spot and the plurality of non-optimized code versions.

3. The method as claimed in claim 1 wherein the comparison step comprises a step of generating a signature for said hot spot and of comparing the signature with a plurality of signatures associated with the plurality of non-optimized code versions.

4. The method as claimed in claim 3 wherein the step of comparison between the signatures is performed according to a principal component analysis.

5. The method as claimed in claim 1, wherein the signatures associated with the plurality of non-optimized code versions contain at least metrics relating to the stability of a data flow, to a parallelization ratio, to a reuse distance of the data flow and to a data volume.

6. The method as claimed in claim 1, wherein the plurality of non-optimized code versions is stored in a reference database where each non-optimized code version is a non-optimized code version for a reference platform and is associated with various optimized code versions parallelized on various architectures and according to various models of parallel programming.

7. The method as claimed in claim 1, wherein the various optimized code versions parallelized on various architectures and according to various models of parallel programming are stored in a porting database and where the step of generating predictions consists in extracting porting data for said non-optimized code version.

8. The method as claimed in claim 1, further comprising a step of displaying the result of the predictions for a user.

9. The method as claimed in claim 8, wherein the result is displayed in the form of Kiviat charts.

10. The method as claimed in claim 1 comprising an initial step of receiving an executable code of an application to be optimized and parallelized and a step of detecting in the executable code a code portion representing a hot spot.

11. A device for aiding code optimization and parallelization of an application, the device comprising means for implementing the steps of the method as claimed in claim 1.

12. A computer program product, said computer program comprising code instructions making it possible to perform the steps of the method as claimed in claim 1, when said program is executed on a computer.
